(19) United States
(12) Patent Application Publication
(10) Pub. No.: US 2011/0310013 A1
(43) Pub. Date: Dec. 22, 2011

(54) INTERFACE APPARATUS AND METHOD FOR CONTACT-FREE SPACE INPUT/OUTPUT

(75) Inventors: Dong wan RYOO, Daejeon (KR); Jun Seok PARK, Daejeon (KR); Jeun Woo LEE, Daejeon (KR)

(73) Assignee: Electronics and Telecommunications Research Institute, Daejeon (KR)

(21) Appl. No.: 13/162,020

(22) Filed: Jun. 16, 2011

(30) Foreign Application Priority Data
Jun. 17, 2010 (KR) 10-2010-0057600

(51) Int. Cl. G06F 3/033

(52) U.S. Cl. 345/158

(57) ABSTRACT

A space input/output interface apparatus includes: a proximity sensor for sensing a movement of a user's wrist; an inertial sensor for sensing a movement of the user's arm; and a controller for generating user input/output interface recognition information corresponding to a sensing value of the proximity sensor or the inertial sensor. The apparatus is an armband-type space input/output interface apparatus which can be put on the user's wrist.

### CROSS-REFERENCE(S) TO RELATED APPLICATION(S)

The present invention claims priority of Korean Patent Application No. 10-2010-0057600, filed on Jun. 17, 2010, which is incorporated herein by reference.

### FIELD OF THE INVENTION

The present invention relates to a space input/output interface technique, and more particularly, to an apparatus and method for an armband-type contact-free space input/output interface.

### BACKGROUND OF THE INVENTION

In general, interface devices between computers and users include a keyboard, a mouse and the like. In addition, as demands for a variety of input devices are recently increasing, a research for an apparatus of space input/output interface which uses an input signal corresponding to a spatial movement of a particular body part such as a hand, a finger and the like, beyond the traditional touch input methods, is actively ongoing.

For example, a tactile interface apparatus, such as a data glove, generates control signals corresponding to respective manual movements, to allow a user to easily manipulate basic controlling of web browsing or a media player as if the user uses a mouse, while on the move or while working.

However, the conventional space input/output interface apparatus greatly depends on the movements of the user's finger, so it has a physical and spatial limitation when various systems such as computers or the like are manipulated in a special environment such as, e.g., in an operating room, a head mounted display (HMD) or the like.

### SUMMARY OF THE INVENTION

Therefore, the present invention provides an interface apparatus for providing a contact-free space input environment to a user who uses special equipment such as a large display for a surgical operation, a head mounted display (HMD) or the like.

The present invention further provides an interface apparatus for providing a contact-free space input environment which can be utilized as an input device like a PC mouse to a user who feels inconvenience in using his or her fingers.

In accordance with an aspect of the present invention, there is provided a space input/output interface apparatus. The apparatus includes: a proximity sensor for sensing a movement of a user's wrist; an inertial sensor for sensing a movement of the user's arm; and a controller for generating user input/output interface recognition information corresponding to a sensing value of the proximity sensor or the inertial sensor.

In accordance with another aspect of the present invention, there is provided an interface method of a space input/output interface apparatus including a proximity sensor and an inertial sensor. The method includes: determining a user input/output interface operation corresponding to a movement signal measured by the proximity sensor or the inertial sensor; transmitting interface recognition information corresponding to the user input/output interface operation to an external terminal; and providing feedback corresponding to the user input/output interface operation.

### BRIEF DESCRIPTION OF THE DRAWINGS

The objects and features of the present invention will become apparent from the following description of embodiments, given in conjunction with the accompanying drawings, in which:

FIG. 1 shows a configuration of a space input/output interface apparatus in accordance with an embodiment of the present invention;

FIGS. 2A to 2C show examples when the space input/output interface apparatus shown in FIG. 1 is put on a user's wrist;

FIG. 3 illustrates a detailed block diagram of the space input/output interface apparatus shown FIG. 1;

FIG. 4 shows examples of user input/output interface operations of the space input/output interface apparatus in accordance with an embodiment of the present invention;

FIG. 5 is a flowchart illustrating an interface process with respect to a movement of a user's wrist in a space input/output interface method in accordance with an embodiment of the present invention; and

FIG. 6 is a flowchart illustrating an interface process with respect to a movement of a user's arm in a space input/output interface method in accordance with an embodiment of the present invention.

### DETAILED DESCRIPTION OF THE EMBODIMENTS

Hereinafter, embodiments of the present invention will be described in detail with the accompanying drawings.

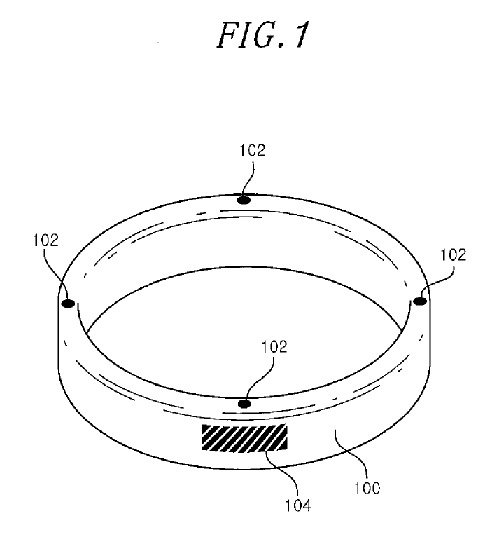

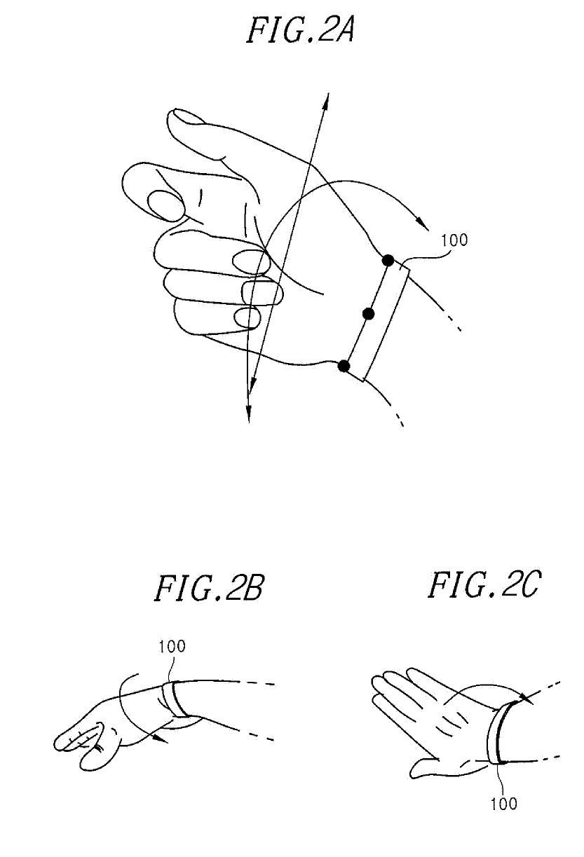

FIG. 1 illustrates the configuration of a space input/output interface apparatus 100, and FIGS. 2A to 2C show examples when the space input/output interface apparatus shown in FIG. 1 is put on a user's wrist;

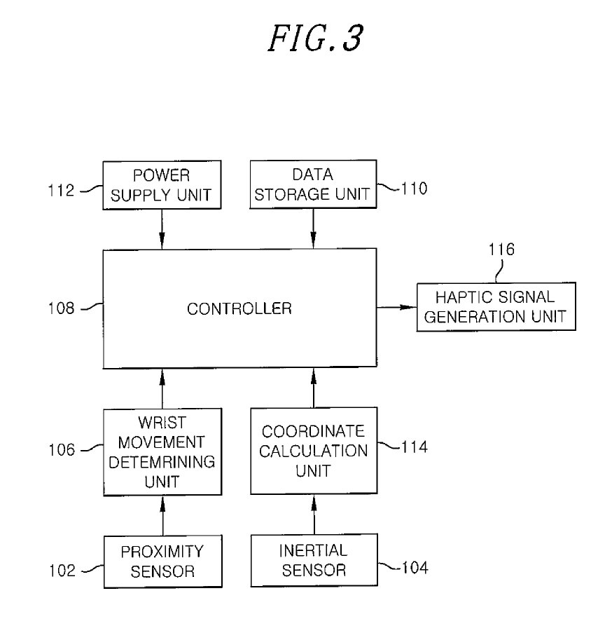

As shown in FIGS. 1 to 2C, the space input/output interface apparatus 100 in accordance with the embodiment of the present invention is an armband-type space input/output interface apparatus which can be put on a user's wrist for example, and includes a proximity sensor 102, an inertial sensor 104, and the like for contact-free space input/output interface. The proximity sensor 102 and the inertial sensor 104 will be described in detail later with reference to FIG. 3.

With the foregoing configuration, the space input/output interface apparatus 100 can be simply put on the user's wrist, rather than on the user's finger, and sense a movement of the user's wrist and arm in a non-contact manner, and determine and process the sensed movement information as an input/output interface operation.

Here, the user input/output interface operation may include, for example, various operations (e.g., left/right clicking, up/down/left/right scrolling, up/down/left/right cursor movement, rotation, dragging, or the like) of a PC-based user input/output device, e.g., a mouse.

FIG. 3 shows a detailed internal configuration of the space input/output interface apparatus 100 including the proximity sensor 102, the inertial sensor 104 and the like.

As shown in FIG. 3, the space input/output interface apparatus 100 includes the proximity sensor 102, the inertial sensor 104, a wrist movement determining unit 106, a controller 108, a data storage unit 110, a power supply unit 112, a coordinate calculation unit 114, a haptic signal generation unit 116 and the like.

First, the proximity sensor 102 is mounted on the side of the foregoing armband-type space input/output interface apparatus 100 along the shape of the armband. The space input/output interface apparatus 100 includes an array of one or more proximity sensors in order to easily sense an up/down/left/right movement, a rotation or the like of the user's hand. Such a proximity sensor array may employ, e.g., one of a capacitance scheme, an infrared scheme, an ultrasonic wave scheme, an optical scheme.

The inertial sensor 104 is mounted in the interior of the space input/output interface apparatus 100 and may include one or more sensing units to sense an up/down/left/right movement, a rotation, or the like, of the user's hand. Such sensing units may include, e.g., a gyro sensor, an acceleration sensor or the like.

The wrist movement determining unit 106 determines sensing values (e.g., sensing values with respect to up/down/left/right movement, a rotation, or the like, of the user's hand) of the proximity sensor 102 as an input/output interface operation which, e.g., corresponds to left/right clicking, rotating, up/down/left/right scrolling, or the like, of a PC mouse.

The controller 108 receives the movement signal measured by the proximity sensor 102 or the inertial sensor 104 from the wrist movement determining unit 106 or the coordinate calculation unit 114 and performs a control process based on the determination results of the corresponding input/output interface operation.

For example, the controller 108 controls a transmission unit (not shown) to transmit interface recognition information corresponding to the determination results of the input/output interface operation, e.g., corresponding to left/right clicking, from the wrist movement determining unit 106 to a PC, or the like, or controls the haptic signal generation unit 116 to provide feedback corresponding to the determination results to the user. Here, the feedback may be, for example, a haptic signal including vibration.

In addition, the controller 108 controls the transmission unit to transmit interface recognition information corresponding to coordinate value calculation results of the input/output interface operation of the coordinate calculation unit 114 to be described later to the PC, or the like, or controls the haptic signal generation unit 116 to provide feedback corresponding to the calculation results to the user.

The data storage unit 110 stores data or a program required for operating the space input/output interface apparatus 100 and also store information for a space input/output interface operation, e.g., left/right clicking, rotating, up/down/left/right scrolling, or the like, of the PC mouse, in accordance with the present embodiment.

The power supply unit 112 supplies power for driving the space input/output interface apparatus 100.

The coordinate calculation unit 114 serves to calculate a sensing value from the inertial sensor 104 as a coordinate value of the corresponding input/output interface operation, e.g., an x-y coordinate value with respect to the up/down/left/right cursor movement of the PC mouse.

The haptic signal generation unit 116 provides feedback corresponding to the determination results of the input/output interface operation to the user under the control of the controller 108, and in this case, as mentioned above, the feedback includes, e.g., a haptic signal including vibration.

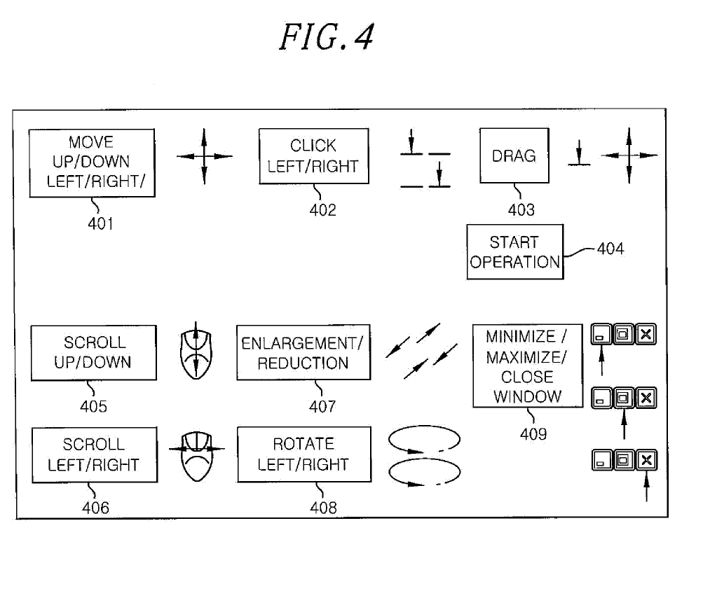

FIG. 4 shows examples of user input/output interface operations of the space input/output interface apparatus 100 in accordance with an embodiment of the present invention. The user input/output interface operations in accordance with the present embodiment may include user input/output interface operations, e.g., move up/down/left/right 401, click left/right 402, drag 403, start operation 404, scroll up/down 405, scroll left/right 406, enlargement/reduction 407, rotate left/right 408, minimize/maximum/close window 409, and the like, through the PC mouse.

In FIG. 4, the move up/down/left/right 401 defines, e.g., an up/down/left/right movement corresponding to a coordinate movement of the PC mouse by using a movement of the user's arm, and an up/down/left/right movement or coordinates can be extracted through the corresponding movement. For example, when the user moves his arm up and down, the inertial sensor 104 senses it and induce the mouse cursor to move up and down, and when the user moves his arm left and right, the inertial sensor 104 senses it and induce the mouse cursor to move left and right.

The click left/right 402 defines, e.g., a left/right click movement corresponding to left or right clicking of the PC mouse by using a movement of the user's wrist, and left or right clicking can be extracted as an input signal through the corresponding movement. For example, when the user bends his wrist to the left, the proximity sensor 102 senses it to recognize left clicking, and generate a signal corresponding to a left button click of the mouse. Similarly, when the user bends his wrist to the right, the proximity sensor 102 generates a signal corresponding to a right button click.

The drag 403 defines, e.g., a drag movement corresponding to dragging of the PC mouse by using a movement of the user's arm or wrist, and a drag input signal can be extracted through the corresponding movement.

The start operation 404 defines, e.g., a start movement for starting an operation of the space input/output interface apparatus 100 by using a movement of the user's arm or wrist, and a start signal can be extracted through the corresponding movement.

The scroll up/down 405 defines, e.g., an up/down scroll movement corresponding to up/down scrolling of the PC mouse, and an up/down scroll signal can be extracted through the corresponding movement.

The scroll left/right 406 defines, e.g., a left/right scroll movement corresponding to left/right scrolling of the PC mouse, and a left/right scroll signal can be extracted through the corresponding movement.

The enlargement/reduction 407 defines, e.g., a movement corresponding to an enlargement or reduction of a PC screen, and an enlargement or reduction signal of the PC screen can be extracted through the corresponding movement.

The rotate left/right 408 defines, e.g., a movement corresponding to a left/right rotation of a certain object on the PC screen, and a left/right rotation signal of the object can be extracted through the corresponding movement.

The minimize/maximum/close window 409 defines, e.g., a movement corresponding to a minimize/maximum/close icon click on a window of the PC screen, and a minimize/maximum/close icon click signal of the window can be extracted through the corresponding movement.

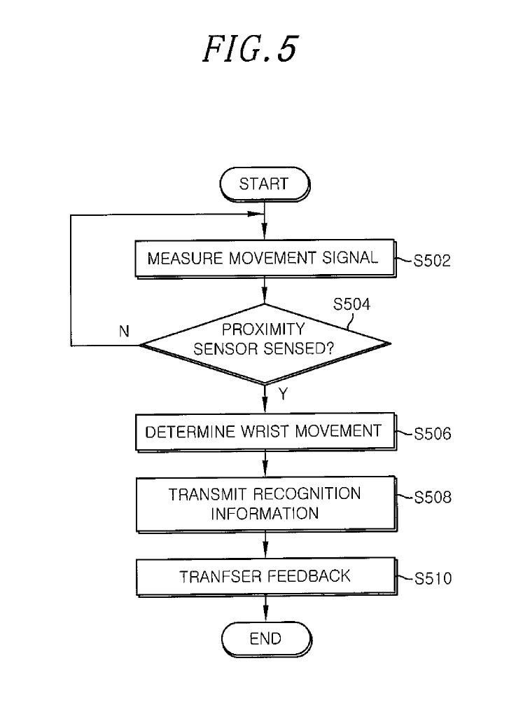

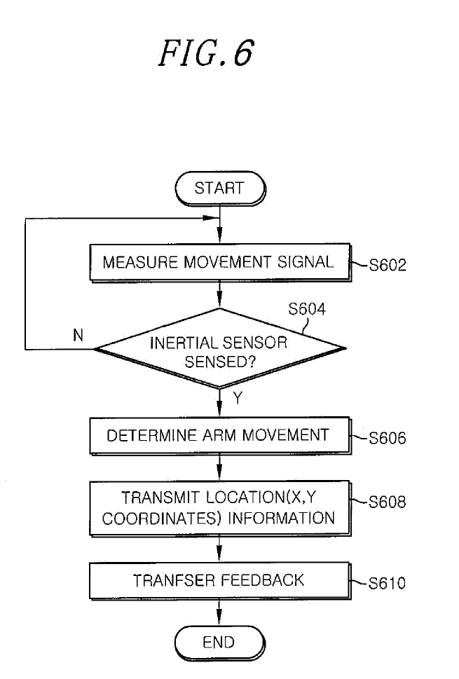

Now, a space input/output interface method in accordance with an embodiment of the present invention will be described in detail with reference to flowcharts of FIGS. 5 and 6.

First, FIG. 5 is a flowchart illustrating an interface process with respect to a movement of the user's wrist in a space input/output interface method in accordance with an embodiment of the present invention.

As shown in FIG. 5, when a movement signal is measured by the proximity sensor 102 in step 5502, the wrist movement determining unit 106 determines that the corresponding movement signal has been sensed by the proximity sensor 102 in step 5504 and determine a user input/output interface operation corresponding to a certain movement signal, e.g., a movement signal such as up/down/left/right bending, a clockwise/counterclockwise rotation, a left/right movement, a right/left movement, an up/down movement, a down/up movement or the like measured by the proximity sensor 102 in step 5506.

The determination results of the wrist movement determining unit 106 are provided to the controller 108, and the controller 108 transmits the corresponding interface recognition information to the PC, or the like, through a transmission unit (not shown) in step 5508. In this case, the transmission unit transmits the interface recognition information through a short-range wireless communication technique, e.g., Bluetooth™, RFID, ZigBee™ or the like. This could be easily understood by those skilled in the art to which the present invention pertains, so a detailed description thereof will be omitted.

The controller 108 controls the haptic signal generation unit 116 to provide feedback corresponding to the user input/output interface operation in step 5510, and in this case, as the feedback, e.g., a tactile signal according to vibration may be used.

FIG. 6 is a flowchart illustrating an interface process with respect to a movement of the user's arm in a space input/output interface method in accordance with an embodiment of the present invention.

As shown in FIG. 6, when a movement signal is measured by the inertial sensor 104 in step 5602, the coordinate calculation unit 114 determines that the corresponding movement signal has been sensed by the inertial sensor 104 in step 5604, and determines a user input/output interface operation, e.g., X-Y movement coordinates or the like, corresponding to a certain movement signal, e.g., a movement signal such as up/down/left/right movement or the like, measured by the inertial sensor 104 in step 5606.

The determination results of the coordinate calculation unit 114 is provided to the controller 108, and the controller 108 transmits the corresponding interface recognition information to the PC or the like, through the transmission unit (not shown) in step 5608. In this case, the transmission unit transmits the interface recognition information in such a manner as described above with reference to FIG. 5.

The controller 108 controls the haptic generation unit 116 to provide feedback corresponding to the user input/output interface operation in step 5610, and in this case, as the feedback, e.g., a tactile signal according to vibration may be used.

As described above, in the present embodiment, an interface apparatus capable of providing a contact-free space input environment to a user who uses special equipment such as a large display for a surgical operation, a head mounted display (HMD), or the like, can be provided, and an interface apparatus capable of providing a contact-free space input environment which can be utilized as an input device like a PC mouse, to a user who feels inconvenience in using his fingers is implemented. Accordingly, it is possible to overcome a physical limitation of a space input/output apparatus, improve its utility, and maximize the convenience of use.

While the invention has been shown and described with respect to the particular embodiments, it will be understood by those skilled in the art that various changes and modification may be made without departing from the scope of the invention as defined in the following claims.

What is claimed is:

1. A space input/output interface apparatus, the apparatus comprising:
a proximity sensor for sensing a movement of a user's wrist;
an inertial sensor for sensing a movement of the user's arm; and
a controller for generating input/output interface recognition information corresponding to a sensing value of the proximity sensor or the inertial sensor.

2. The apparatus of claim 1, wherein the apparatus is an armband-type space input/output interface apparatus which is put on the user's wrist.

3. The apparatus of claim 2, wherein the proximity sensor is formed in a proximity sensor array including one or more proximity sensors mounted on the side of the armband-type space input/output interface apparatus along the shape of the armband to sense an up/down/left/right movement and a rotational movement of the user's hand.

4. The apparatus of claim 3, wherein the proximity sensor array employs one of a capacitance scheme, an infrared scheme, an ultrasonic wave scheme, or an optical scheme.

5. The apparatus of claim 2, wherein the inertial sensor is mounted in the interior of the armband-type space input/output interface apparatus.

6. The apparatus of claim 5, wherein the inertial sensor includes one of a gyro sensor and an acceleration sensor.

7. The apparatus of claim 1, further comprising:
a wrist movement determining unit for determining a sensing value of the proximity sensor as first input/output interface recognition information;
a coordinate calculation unit for calculating a sensing value of the inertial sensor as a coordinate value of second input/output interface recognition information; and
a haptic signal generation unit for providing feedback corresponding to first and second input/output interface recognition information under the control of the controller.

8. The apparatus of claim 7, wherein the first input/output interface recognition information corresponds to a value obtained by sensing a movement of the user's wrist.

9. The apparatus of claim 7, wherein the second input/output interface recognition information corresponds to a value obtained by sensing a movement of the user's arm.

10. The apparatus of claim 7, further comprising:
a transmission unit for transmitting the first and second input/output interface information to an external terminal;
a data storage unit for storing information required for space input/output interface operation; and
a power supply unit for supplying power to drive the apparatus.

11. The apparatus of claim 10, wherein the external terminal includes a personal computer (PC).

12. The apparatus of claim 11, wherein the input/output interface recognition information involves operation information of a PC-based input/output device.

13. The apparatus of claim 12, wherein the PC-based input/output device includes a PC-based mouse.

14. The apparatus of claim 12, wherein the operation information of the PC-based input/output device includes information on one of operations such as up/down/left/right cursor movement, left/right clicking, dragging, operation start, up/down/left/right scrolling, enlargement/reduction, rotation, and window minimize/maximize/close of the mouse.

15. An interface method of a space input/output interface apparatus including a proximity sensor and an inertial sensor, the method comprising:
determining an input/output interface operation corresponding to a movement signal measured by the proximity sensor or the inertial sensor;
transmitting interface recognition information corresponding to the input/output interface operation to an external terminal; and
providing feedback corresponding to the input/output interface operation.

16. The method of claim 15, wherein the movement signal measured by the proximity sensor is obtained by sensing a movement of the user's wrist.

17. The method of claim 15, wherein the movement signal measured by the inertial sensor is obtained by sensing a movement of the user's arm.

18. The method of claim 17, wherein the movement of the user's arm is an input/output interface operation corresponding to an up/down/left/right movement.

19. The method of claim 15, wherein the feedback includes an operation of vibrating the space input/output interface apparatus.

20. The method of claim 15, wherein the space input/output interface apparatus is an armband-type space input/output interface apparatus which is put on the user's wrist.
